(19) United States
(12) Patent Application Publication
(10) Pub. No.: US 2019/0044182 A1
(43) Pub. Date: Feb. 7, 2019

(54) LITHIUM SECONDARY BATTERY AND METHOD FOR PRODUCING THE SAME

(71) Applicant: NEC CORPORATION, Tokyo (JP)

(72) Inventors: Katsumi MAEDA, Tokyo (JP); Noriyuki TAMURA, Tokyo (JP); Mika SHIBA, Tokyo (JP)

(73) Assignee: NEC CORPORATION, Tokyo (JP)

(21) Appl. No.: 15/759,662

(22) PCT Filed: Aug. 8, 2016
(86) PCT No.: PCT/JP2016/073337

§ 371 Date: Mar. 13, 2018

(30) Foreign Application Priority Data
Sep. 16, 2015 (JP) 2015-182809

(51) Int. Cl. H01M 10/0525; H01M 4/485; H01M 4/587; H01M 10/0567; H01M 10/0569; H01M 10/0568

(52) U.S. Cl. CPC H01M 10/0525; H01M 4/485; H01M 4/587; H01M 2300/0025; H01M 10/0569; H01M 10/0568; H01M 10/0567

(57) ABSTRACT

Provided are a lithium secondary battery high in capacity and excellent in charge and discharge rate characteristics, and a method for producing the same. The lithium secondary battery of the present invention includes a positive electrode containing a positive electrode active substance containing a lithium transition metal oxide, a negative electrode containing a negative electrode active substance containing a heat-treated graphite material, and an electrolytic solution, wherein the heat-treated graphite material has passages of lithium ions penetrating at least one or more layers of graphene layers from the surface of a graphene stacking structure; and the electrolytic solution contains lithium difluorophosphate.

### TECHNICAL FIELD

The present invention relates to a lithium secondary battery high in capacity and excellent in charge rate characteristic.

### BACKGROUND ART

Due to advantages of a high energy density, a low self-discharge, an excellent long-term reliability and the like, lithium secondary batteries are practically applied as batteries for small electronics devices such as laptop computers and cell phones. Further in recent years, developments of lithium secondary batteries for electric cars, household storage batteries and power storage have been made.

In a lithium secondary battery, a carbon material such as graphite is used as a negative electrode active substance, and a lithium salt such as LiPF₆ as an electrolyte dissolved in a chain or cyclic carbonate-based solvent is used as an electrolytic solution.

With respect to such a lithium secondary battery, there is a demand for a battery having an enhanced energy density and excellent charge rate characteristic where the battery can be charged in a short time even though having a high energy density, so the improvement of the charge rate characteristic has been studied. For example, Patent Literature 1 discloses a secondary battery having such a structure that the battery has a two-layer negative electrode layer on a negative electrode current collector; the first negative electrode layer on the side closer to the negative electrode current collector has an artificial graphite; and the second negative electrode layer on the side farther from the negative electrode current collector has a natural graphite, wherein the charge rate characteristic of the second negative electrode layer is higher than that of the first negative electrode layer. Further Patent Literature 2 discloses that the charge rate characteristic is improved by coating edge portions of a graphite material of a negative electrode active substance with a Si compound, a Sn compound or a soft carbon.

The method for forming a negative electrode having a two-layer structure containing different negative electrode active substances and the method for coating edge portions of a graphite with silicon or the like, however, make the production steps complicated and the production cost increased. A lithium secondary battery which is further improved in charge rate characteristic and easy to produce is demanded.

### CITATION LIST

### Patent Literature

Patent Literature 1: JP2009-64574A
Patent Literature 2: JP2015-2122A

### SUMMARY OF INVENTION

### Technical Problem

An object of the present invention is to provide a lithium secondary battery high in usage efficiency in which the charge rate is high and the charge time can be shortened even though its capacity is high.

### Solution to Problem

The lithium secondary battery of the present invention is a lithium secondary battery comprising a positive electrode containing a positive electrode active substance containing a lithium transition metal oxide, a negative electrode containing a negative electrode active substance containing a heat-treated graphite material, and an electrolytic solution, wherein the heat-treated graphite material has passages of lithium ions penetrating through at least one or more layers of graphene layers from the surface of a graphene stacking structure, and the electrolytic solution contains lithium difluorophosphate.

Further the method for producing the lithium secondary battery of the present invention comprises subjecting a graphite material to a first heat treatment in an oxidizing atmosphere to prepare a first heat-treated graphite material, thereafter subjecting the first heat-treated graphite material to a second heat treatment in an inert gas atmosphere at a higher temperature than that in the first heat treatment to prepare a heat-treated graphite material, using the heat-treated graphite material to form a negative electrode, and mixing lithium difluorophosphate to form an electrolytic solution.

### Advantageous Effects of Invention

The lithium secondary battery of the present invention, due to that its negative electrode active substance contains a heat-treated graphite material; its positive electrode active substance contains a lithium transition metal oxide; and its electrolytic solution contains lithium difluorophosphate, has a high capacity and a remarkably high charge rate characteristic. Hence, the charge time of the lithium secondary battery can be shortened even though its capacity is high, and in turn, the usage efficiency thereof can be improved.

### BRIEF DESCRIPTION OF DRAWINGS

FIG. 1 shows views of images by a scanning electron microscope (SEM) of a graphite material contained in a negative electrode in the lithium secondary battery of the present invention, in which (a) shows a surface state of the graphite material before heat treatment, and (b) shows a surface state of the first heat-treated graphite material after a first heat treatment.

FIG. 2 is a schematic cross-sectional view of a constitution of one example of the lithium secondary battery of the present invention.

### REFERENCE SIGNS LIST [0012]

1 positive electrode active substance layer
1A positive electrode current collector
1B positive electrode tab
10 positive electrode (cathode)
2 negative electrode active substance layer
2A negative electrode current collector
2B negative electrode tab
20 negative electrode (anode)
3 porous separator
4 laminate film (outer package)

### DESCRIPTION OF EMBODIMENT

The lithium secondary battery of the present invention is a lithium secondary battery comprising a positive electrode containing a positive electrode active substance containing a lithium transition metal oxide, a negative electrode containing a negative electrode active substance containing a heat-treated graphite material, and an electrolytic solution, wherein the heat-treated graphite material has passages of lithium ions penetrating through at least one or more layers of graphene layers from the surface of a graphene stacking structure, and the electrolytic solution contains lithium difluorophosphate.

### [Negative Electrode]

The negative electrode contains, as its negative electrode active substance, a heat-treated graphite material being a graphite material having been subjected to a heat treatment, wherein it is preferable that a negative electrode active substance layer in which a negative electrode active substance is unified by a binder for the negative electrode be bound to a negative electrode current collector so as to cover the negative electrode current collector.

Such a heat-treated graphite material has passages of lithium ions penetrating through at least one or more layers of graphene layers from the surface of a graphene stacking structure.

The heat-treated graphite material has grooves along the surface of graphite particles and a large number of passages (channels) having openings on the surface. The channels are formed on the surface of the graphite particles and in various depths from the surface; it is preferable that the channels be formed particularly from the surface (referred to also as basal surface) of a stacking structure of graphene layers toward the interior of the graphene stacking structure in the perpendicular direction to the basal surface and in various directions; and the channels also include ones mutually connected and formed. These channels have bore diameters passing lithium ions, and function as passages of lithium ions (referred to also as Li paths) into the graphene stacking structure. Conventional graphite is almost limited to one in which passages are formed from the stacking side surfaces of graphene layers into between the graphene layers wherein their length is long and hence, when the amount of lithium ions in an electrolytic solution is large, the amount thereof going in and out the interior of the graphite rather decreases, whereas the heat-treated graphite material according to the present exemplary embodiment, since having, in addition to Li paths from the side surfaces, a large number of short Li paths in the perpendicular and other directions to the basal surface, makes easy the going in and out of the graphene stacking structure of lithium ions and can remarkably improve the charge rate.

Although such channels may be ones penetrating through only a graphene layer of the surface layer, it is preferable that the channels be formed penetrating through several layers of graphene layers; it is more preferable that the channels be formed to the depth of at least 3 layers inward from the surface; it is still more preferable that the channels be formed to the depth of at least 5 layers inward from the surface layer; and the channels may reach the depth of much more layers (for example, 10 or more layers). The length of the channels can be detected by observing cut cross-sections of the heat-treated graphite with an electron microscope such as

TEM or SEM. The bore diameter of the channels is in the range being capable of passing lithium ions and not largely deteriorating the characteristic of the graphite due to the channel formation, and is preferably, for example, in a nanometer size to a micrometer size. Specifically, the size can be 1 nm to smaller than 50 μm. From the viewpoint of sufficiently passing lithium ions, the bore diameter is preferably 10 nm or larger, more preferably 50 nm or larger, and still more preferably 100 nm or larger. Further from the viewpoint of not deteriorating the characteristic of the graphite, the bore diameter is preferably 1 μm or smaller, more preferably 800 nm or smaller, and still more preferably 500 nm or smaller.

Further it is preferable that the channels be formed over the whole surface of the graphite particle surface; and the more uniform the distribution thereof, the better. The bore diameter, the distribution and the like of the channels can be controlled by the heat treatment condition such as the temperature, the time and the oxygen concentration in a first heat treatment described later.

Then, the graphene stacking structure of the heat-treated graphite material can be made to have a structure and physical properties corresponding to these of a raw material of graphite. The interplanar spacing d₀₀₂ of the (002) plane of the graphite raw material is preferably 0.340 nm or smaller, and more preferably 0.338 or smaller; and since the theoretical value of d₀₀₂ of graphite is 0.3354, d₀₀₂ of the heat-treated graphite material is preferably in the range of 0.3354 to 0.340. The d₀₀₂ can be determined by X-ray diffractometry (XRD). The length Lc of the passages is preferably 50 nm or longer, and more preferably 100 nm or longer.

Heat treatment for obtaining such a heat-treated graphite material will be described. A graphite material to be subjected to a heat treatment may be either of a natural graphite and an artificial graphite. The artificial graphite may also be commercially available ones obtained by graphitizing coke or the like. Alternatively, there may be used a graphitized material of mesophase spherules also called mesocarbon microbeads (MCMB). The artificial graphite includes ones obtained by subjecting a carbon raw material to a heat treatment in the range of 2,000 to 3,200° C.

As such a graphite material, particulate materials can be used from the viewpoint of the filling efficiency, the mixability, the formability and the like. The shape of the particle includes spherical, ellipsoidal and scaly (flaky) shapes. Graphite materials having been subjected to a sphering treatment can also be used. The average particle diameter of the graphite material is, from the viewpoint of suppressing side-reactions in the charge and discharge time to suppress the decrease of the charge and discharge efficiency, preferably 1 μm or larger, more preferably 2 μm or larger, and still more preferably 5 μm or larger, and from the viewpoint of the input and output characteristic and the viewpoint of fabrication of an electrode (smoothness of an electrode surface, and the like), preferably 40 μm or smaller, more preferably 35 μm or smaller, and still more preferably 30 μm or smaller. Here, the average particle diameter is defined as a particle diameter (median diameter: D50) at a cumulative value of 50% in a particle size distribution (in terms of volume) by a laser diffraction scattering method.

The heat treatment carried out on such a graphite material includes a treatment of carrying out a first heat treatment in an oxidizing atmosphere to prepare a first heat-treated graphite material, and thereafter subjecting the first heat-treated graphite material to a second heat treatment in an inert gas atmosphere at a higher temperature than that in the first heat treatment to thereby prepare a heat-treated graphite material.

The first heat treatment, since being carried out in an oxidizing atmosphere, is carried out at a temperature lower than the ignition temperature of the graphite material. Although the ignition temperature differs depending on the graphite material, the temperature lower than the ignition temperature can be selected, at normal pressure, from the temperature range of 400 to 900° C. The temperature is preferably 450 to 900° C., and more preferably 480 to 900° C. The heat treatment time is preferably in the range of about 30 min to 10 hours. The oxidizing atmosphere includes oxygen, carbon dioxide, air and a mixed gas thereof, and the oxygen concentration and the pressure can also suitably be regulated. The bore diameter, the distribution and the like of channels formed in the graphite material can be controlled by the heat treatment condition such as the temperature, the time and the oxygen concentration in the first heat treatment.

The second heat treatment carried out following the first heat treatment is carried out in an inert gas atmosphere at a temperature higher than that of the first heat treatment. The second heat treatment can recover a high capacity characteristic, which has been impaired by the first heat treatment, intrinsic to the graphite material. The second heat treatment is carried out at normal pressure preferably in the temperature range of 800° C. to 1,400° C., more preferably at 850 to 1,300° C., and still more preferably at 900 to 1,200° C. The heat treatment time is preferably in the range of about 1 hour to 10 hours. The inert gas atmosphere can be made to be a rare gas atmosphere such as Ar or a nitrogen gas atmosphere.

The first and second heat treatments can be carried out continuously in a same heating furnace. In this case, it is preferable that after the first heat treatment, the oxidizing atmosphere in the heating furnace be replaced by the inert gas; and then the temperature be raised to the temperature of the second heat treatment, and then the second heat treatment be carried out. Alternatively, the heat treatments can also be carried out in such a configuration that two heating furnaces are continuously arranged; and the graphite material being the raw material is subjected to a heat treatment in the heating furnace for carrying out the first heat treatment, and the first heat-treated graphite material taken out from the heating furnace is introduced in the heating furnace for carrying out the second heat treatment.

The heat-treated graphite obtained by the second heat treatment can be cleaned by carrying out water washing and drying.

Further, between the first heat treatment step and the second heat treatment step, some length of time may be left, or other steps such as water washing and drying can be interposed, as long as these steps do not affect the state of channels formed in the graphite particles.

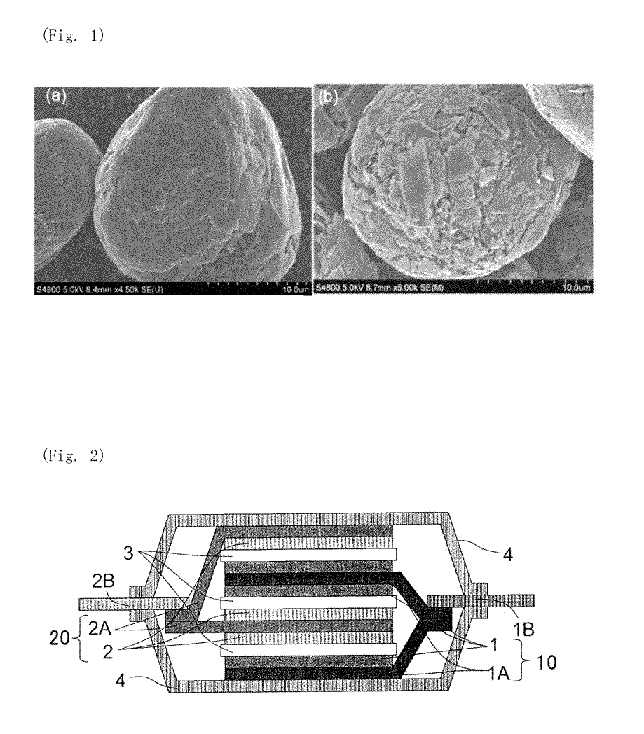

FIG. 1 shows SEM images of one example of a heat-treated graphite thus having been subjected to the heat treatment, observed by a scanning electron microscope (SEM). FIG. 1(a) shows a SEM image of a graphite material before the heat treatment, and FIG. 1(b) shows a SEM image of the first heat-treated graphite material after the first heat treatment.

Since in such a heat-treated graphite material, the characteristics of graphite are not impaired including high crystallinity, high electroconductivity, and excellent adhesiveness with a negative electrode current collector and excellent voltage flatness, and in addition to these characteristics, the graphite material has short passages penetrating not only between graphene layers of the graphene stacking structure but also from the surface of the graphene layers through the graphene layers, the graphite material may allow lithium ions to easily go in and out the graphene stacking structure interior, and exhibits an extremely high charge rate characteristic in the lithium secondary battery using the graphite material for its negative electrode active substance.

The negative electrode active substance may use the heat-treated graphite material only, and may contain a non-heat-treated graphite material such as the graphite material before the above heat treatment is carried out. The incorporation of the non-heat-treated graphite material provides the effect of providing a high capacity of graphite, and is also economical. The content of the non-heat-treated graphite material in the negative electrode active substance layer is preferably 50% by mass or lower.

Further the negative electrode active substance includes metals or alloys alloyable with lithium, oxides capable of intercalating and deintercalating lithium, and carbon materials other than the above graphite material.

Examples of the metals include a single silicon and tin. The oxides include silicon oxides represented by SiOₓ (0<x≤2), niobium pentaoxide (Nb₂O₅), lithium titanium composite oxide (Li_{4/3}Ti_{5/3}O₄), and titanium dioxide (TiO₂). The carbon materials other than the above graphite include amorphous carbon, diamond-like carbon, carbon nanotubes, and carbon black. The carbon black includes acetylene black and furnace black. The amorphous carbon, low in crystallinity, since having a relatively low volume expansion, has a large effect of lessening the volume expansion of the negative electrode active substance layer, and can suppress the deterioration of the negative electrode active substance layer due to heterogeneity including crystal grain boundaries and defects. Further in the case of silicon oxide having a structure in which silicon is dispersed in the silicon oxide wholly or partially having an amorphous structure, and the surface is coated with carbon, since the silicon oxide of the amorphous structure lessens the volume expansion of the negative electrode active substance layer by the volume expansion accompanying charge and discharge of the carbon material and silicon, and the silicon being dispersed suppresses the decomposition of the electrolyte solution, the silicon oxide is preferable. It can be confirmed by X-ray diffractometry that the whole or a part of the silicon oxide has an amorphous structure. In the case where the silicon oxide does not have an amorphous structure, in the X-ray diffractometry, peaks characteristic of silicon oxides become sharp; and in the case where the whole or a part of the silicon oxide has an amorphous structure, the peaks characteristic of silicon oxides become broad.

It can be confirmed by combined use of transmission electron microscope observation and energy-dispersive X-ray spectroscopy that the whole or a part of the silicon is dispersed in the silicon oxide. Specifically, the cross-section of a sample is observed by a transmission electron microscope, and the oxygen concentration in silicon moieties dispersed in the silicon oxide is measured by energy-dispersive X-ray spectroscopy. As a result, it can be confirmed that silicon dispersed in the silicon oxide is not in the form of oxides.

It is preferable that the amount of negative electrode active substances other than such a heat-treated graphite material and non-heat-treated graphite material be 45% by mass or smaller in the negative electrode active substance layer, because of not impairing the characteristics of the heat-treated graphite material, and being capable of reducing the volume change accompanying charge and discharge of the negative electrode active substance layer; and 35% by mass or smaller is more preferable.

The binder for the negative electrode is not especially limited, but for example, polyvinylidene fluoride, vinylidene fluoride-hex afluoropropylene copolymers, vinylidene fluoride-tetrafluoroethylene copolymers, styrene-butadiene copolymer rubber (SBR), polytetrafluoroethylene, polypropylene, polyethylene, polyimide, polyamideimide, and polyacrylic acid or carboxymethylcellulose, neutralized with an alkali, including a lithium salt, a sodium salt and a potassium salt can be used. Among these, from the viewpoint of strong unification, preferable are polyimide, polyamideimide, SBR, and polyacrylic acid or carboxymethylcellulose, neutralized with an alkali, including a lithium salt, a sodium salt and a potassium salt. The amount of the binder for the negative electrode to be used is, from the viewpoint of “sufficient binding capability” and “energy enhancement”, which are in a tradeoff relationship, preferably 5 to 25 parts by mass to 100 parts by mass of the negative electrode active substance.

The material of the negative electrode current collector includes metal materials such as copper, nickel and stainless steels. Among these, from the viewpoint of workability and cost, copper is preferable. Further as the negative electrode current collector, one whose surface has been previously subjected to a surface-roughening treatment can be used. The shape of the current collector may be any of a foil shape, a flat plate shape, a mesh shape and the like. There can also be used a current collector of a perforated type such as an expanded metal or a punching metal.

The negative electrode can be produced by: applying, on the current collector, a slurried coating liquid which is prepared by adding a solvent to a mixture of the above-mentioned negative electrode active substance and binder, and as required, various types of auxiliary agents, and kneading the resultant; and drying the resultant.

### [Positive Electrode]

In the positive electrode, it is preferable that a positive electrode active substance layer in which a positive electrode active substance is unified by a binder for the positive electrode be bound to a positive electrode current collector so as to cover the positive electrode current collector.

The positive electrode active substance contains a lithium transition metal oxide, and the lithium transition metal oxide specifically includes LiCoO₂, LiMnO₂, LiMn₂O₄, LiNiO₂, LiCo₁₋ₓNiₓO₂ (0.01<x<1), LiNi_{1/2}Mn_{3/2}O₄, LiNiₓCo_{y}Mn_{z}O₂(x+y+z=1), LiFePO₄.

Further in these lithium transition metal oxides, there can also be used ones in which Li is contained more in excess than in their stoichiometric composition. The excess-lithium transition metal oxide includes Li₁₊ₐNiₓMn_{y}O₂ (0<a≤0.5, 0<x<1, 0<y<1), Li₁₊ₐNiₓMn_{y}M_{z}O₂ (0<a≤0.5, 0<x<1, 0<y<1, 0<z<1, M is Co or Fe), Li_{α}Ni_{β}Co_{γ}Al_{δ}O₂ (1≤α≤1.2, β+γ+δ=1, β≥0.7, δ≤0.2).

Further in order to improve the cycle characteristic and the safety and make the use at a high charge potential possible, a part of the lithium transition metal oxide may be substituted with other elements. For example, a part of cobalt, manganese and nickel may be substituted with at least one or more elements of Sn, Mg, Fe, Ti, Al, Zr, Cr, V, Ga, Zn, Cu, Bi, Mo, La and the like; a part of oxygen may be substituted with S or F; or the positive electrode surface may be coated with a compound containing these elements.

Specific examples of the lithium metal oxide include LiMnO₂,CoO₂, LiNiO₂, LiMn₂O₄, LiCo_{0.8}Ni_{0.2}O₂, LiNi_{1/2}Mn_{3/2}O₄, LiNi_{1/3}Co_{1/3}Mn_{1/3}O₂ (abbreviated to NCM111), LiNi_{0.4}Co_{0.3}Mn_{0.3}O₂ (abbreviated to NCM433), LiNi_{0.5}Co_{0.2}Mn_{0.3}O₂ (abbreviated to NCM523), LiNi_{0.5}Co_{0.3}Mn_{0.2}O₂ (abbreviated to NCM532), LiFePO₄, LiNi_{0.8}Co_{0.15}Al_{0.05}O₂, LiNi_{0.8}Co_{0.1}Mn_{0.1}O₂, Li_{1.2}Mn_{0.4}Ni_{0.4}O₂, Li_{1.2}Mn_{0.6}Ni_{0.2}O₂, Li_{1.19}Mn_{0.52}Fe_{0.22}O_{1.98}, Li_{1.21}Mn_{0.46}Fe_{0.15}Ni_{0.15}O₂, LiMn_{1.5}Ni_{0.5}O₄, Li_{1.2}Mn_{0.4}Fe_{0.4}O₂, Li_{1.21}Mn_{0.4}Fe_{0.2}Ni_{0.2}O₂, Li_{1.26}Mn_{0.37}Ni_{0.22}Ti_{0.15}O₂, LiMn_{1.37}Ni_{0.5}Ti_{0.13}O_{4.0}, Li_{1.2}Mn_{0.56}Ni_{0.17}Co_{0.07}O₂, Li_{1.2}Mn_{0.54}Ni_{0.13}Co_{0.13}O₂, Li_{1.2}Mn_{0.56}Ni_{0.17}Co_{0.07}O₂, Li_{1.2}Mn_{0.54}Ni_{0.13}Co_{0.13}O₂, LiNi_{0.8}Co_{0.15}Al_{0.05}O₂, LiNi_{0.5}Mn_{1.48}Al_{0.02}O₄, LiNi_{0.5}Mn_{1.45}Al_{0.05}O_{3.9}F_{0.05}, LiNi_{0.4}Co_{0.2}Mn_{1.25}Ti_{0.15}O₄, Li_{1.23}Fe_{0.15}Ni_{0.15}Mn_{0.46}O₂, Li_{1.26}Fe_{0.11}Ni_{0.11}Mn_{0.52}O₂, Li_{1.2}Fe_{0.20}Ni_{0.20}Mn_{0.40}O₂, Li_{1.29}Fe_{0.07}Ni_{0.14}Mn_{0.57}O₂, Li_{1.26}Fe_{0.22}Mn_{0.37}Ti_{0.15}O₂, Li_{1.29}Fe_{0.07}Ni_{0.07}Mn_{0.57}O_{2.8}, Li_{1.30}Fe_{0.04}Ni_{0.07}Mn_{0.61}O₂, Li_{1.2}Ni_{0.18}Mn_{0.54}Co_{0.08}O₂, Li_{1.23}Fe_{0.03}Ni_{0.03}Mn_{0.58}O₂.

Further the lithium transition metal oxides as described above may be used by being mixed in two or more kinds thereof; for example, NCM532 or NCM523 and NCM433 can be used by being mixed in the range of 9:1 to 1:9 (typical example, 2:1); and NCM532 or NCM523 and at least one or more selected from LiMnO₂,CoO₂ and LiMn₂O₄ can also be used by being mixed in the range of 9:1 to 1:9.

To the positive electrode active substance layer containing the positive electrode active substance, for the purpose of reducing the impedance, a conductive auxiliary agent may be added. Examples of the conductive auxiliary agent include graphites such as natural graphite and artificial graphite, and carbon blacks such as acetylene black, Ketjen black, furnace black, channel black and thermal black. The conductive auxiliary agent may be used by suitably mixing a plurality of kinds thereof. The amount of the conductive auxiliary agent is preferably 1 to 10% by mass to 100% by mass of the positive electrode active substance.

As the binder for the positive electrode, for example, polyvinylidene fluoride, vinylidene fluoride-hexafluoropropylene copolymers, vinylidene fluoride-tetrafluoroethylene copolymers, styrene-butadiene copolymer rubber, polytetrafluoroethylene, polypropylene, polyethylene, polyimide and polyamideimide can be used. Particularly from the viewpoint of the versatility and the low cost, polyvinylidene fluoride is preferably used as the binder for the positive electrode. The amount of the binder for the positive electrode to be used is, from the viewpoint of “sufficient binding capability” and “energy enhancement”, which are in a tradeoff relationship, preferably 2 to 10 parts by mass to 100 parts by mass of the positive electrode active substance.

As the positive electrode current collector, for example, aluminum foils and stainless steel lath boards can be used.

The positive electrode can be fabricated, for example, by: applying a material prepared by adding a solvent such as N-methylpyrrolidone to a mixture in which the positive electrode active substance, the conductive auxiliary agent and the binder are mixed, and kneading the resultant, on a current collector by a doctor blade method, a die coater method or the like; and drying the resultant.

### [Electrolytic Solution]

The electrolytic solution of the lithium ion secondary battery is constituted mainly of a nonaqueous organic solvent and an electrolyte, and further contains lithium difluorophosphate.

The solvent includes cyclic carbonates, chain carbonates, chain esters, lactones, ethers, sulfones, nitriles and phosphate esters, and cyclic carbonates and cyclic carbonates are preferable.

The cyclic carbonates specifically include propylene carbonate, ethylene carbonate, butylene carbonate, vinylene carbonate and vinylethylene carbonate.

The chain carbonates specifically include dimethyl carbonate, diethyl carbonate, dipropyl carbonate, dibutyl carbonate, ethyl methyl carbonate, methyl propyl carbonate, methyl isopropyl carbonate and methyl butyl carbonate.

The chain esters specifically include methyl formate, methyl acetate, methyl propionate, ethyl propionate, methyl pivalate and ethyl pivalate.

The lactones specifically include γ-butyrolactone, δ-valerolactone and α-methyl-γ-butyrolactone.

The ethers specifically include tetrahydrofuran, 2-methyltetrahydrofuran, 1,3-dioxolane, 1,3-dioxane, 1,4-dioxane, 1,2-dimethoxyethane, 1,2-diethoxyethane and 1,2-dibutoxyethane.

The sulfones specifically include sulfolane, 3-methylsulfolane and 2,4-dimethylsulfolane.

The nitriles specifically include acetonitrile, propionitrile, succinonitrile, glutaronitrile and adiponitrile.

The phosphate esters specifically include trimethyl phosphate, triethyl phosphate, tributyl phosphate and trioctyl phosphate.

The nonaqueous solvent can be used singly or in a combination of two or more. The combination of a plurality of nonaqueous solvents includes combinations of, for example, a cyclic carbonate and a chain carbonate. Among these, from the viewpoint of achieving excellent battery characteristics, more preferable is a combination containing, at least, a cyclic carbonate and a chain carbonate.

Further to a combination of a cyclic carbonate and a chain carbonate, as a third solvent, there can be added a fluorinated ether, a fluorinated carbonate, a fluorinated phosphate ester or the like.

The fluorinated ether includes CF₃OCH₃, CF₃OC₂H₅, F(CF₂)₂OCH₃, F(CF₂)₂OC₂H₅, F(CF₂)₃OCH₃, F(CF₂)₃OC₂H₅, F(CF₂)₄OCH₃, F(CF₂)₄OC₂H₅, F(CF₂)₅OCH₃, F(CF₂)₅OC₂H₅, F(CF₂)₈OCH₃, F(CF₂)₈OC₂H₅, F(CF₂)₉OCH₃, CF₃ CH₂OCH₃, CF₃ CH₂OCHF₂, CF₃ CF₂ CH₂OCH₃, CF₃ CF₂ CH₂OCHF₂, CF₃ CF₂ CH₂O(CF₂)₂H, CF₃ CF₂ CH₂O(CF₂)₂F, HCF₂ CH₂OCH₃, H(CF₂)₂OCH₂ CH₃, H(CF₂)₂OCH₂ CF₃, H(CF₂)₂ CH₂OCHF₂, H(CF₂)₂ CH₂O(CF₂)₂H, H(CF₂)₂ CH₂O(CF₂)₃H, H(CF₂)₃ CH₂O(CF₂)₂H, H(CF₂)₄ CH₂O(CF₂)₂H, (CF₃)₂ CHOCH₃, (CF₃)₂ CHCF₂OCH₃, CF₃ CHFCF₂OCH₃, CF₃ CHFCF₂OCH₂ CH₃, CF₃ CHFCF₂ CH₂OCHF₂, CF₃ CHFCF₂ CH₂OCH₂ CF₂ CF₃, H(CF₂)₂ CH₂OCF₂ CHFCF₃, CHF₂ CH₂OCF₂ CFHCF₃, F(CF₂)₂ CH₂OCF₂ CFHCF₃, CF₃(CF₂)₃OCHF₂.

Further the fluorinated carbonate includes fluoroethylene carbonate, fluoromethyl methyl carbonate, 2-fluoroethyl methyl carbonate, ethyl-(2-fluoroethyl) carbonate, (2,2-difluoroethyl) ethyl carbonate, bis(2-fluoroethyl) carbonate and ethyl-(2,2,2-trifluoroethyl) carbonate.

The fluorinated phosphate ester includes tris(2,2,2-trifluoroethyl) phosphate, tris(trifluoromethyl) phosphate and tris(2,2,3,3-tetrafluoropropyl) phosphate.

Then, specific examples of the electrolyte include lithium salts such as LiPF₆, LiBF₄, LiClO₄, LiN(SO₂F)₂, LiN(SO₂ CF₃)₂, LiN(SO₂ C₂F₅)₂, CF₃SO₃Li, C₄F₉SO₃Li, LiAsF₆, LiAlCl₄, LiSbF₆, LiPF₄(CF₃)₂, LiPF₃(C₂F₅)₃, LiPF₃(CF₃)₃, (CF₂)₂(SO₂)₂NLi, (CF₂)₃(SO₂)₂Li, C₄BLiO₈(Lithium bis(oxalate)borate), Lithium difluoro(oxalato)borate. These lithium salts can be used singly or in a combination of two or more. Particularly the incorporation of LiPF₆ and LiN(SO₂F)₂ is preferable and particularly LiN(SO₂F)₂ can improve the charge rate characteristic. The reason therefor is conceivably because in the case of using LiN(SO₂F)₂ as the electrolyte, in the negative electrode containing the heat-treated graphite, in the charge time, the desolvation energy of Li ions is low.

The concentration of the electrolyte in the electrolytic solution is, with respect to the solvent, preferably 0.1 to 3M, and more preferably 0.5 to 2M.

Further the lithium difluorophosphate contained in the electrolytic solution can achieve the improvement of the charge rate characteristic in cooperation with the negative electrode active substance layer containing the heat-treated graphite material. The lithium difluorophosphate is contained in the electrolytic solution, preferably in 0.005% by mass to 7% by mass, more preferably in 0.01% by mass to 5% by mass.

The electrolytic solution may further contain other components. Examples of the other components include vinylene carbonate, maleic anhydride, ethylene sulfite, boronate esters, 1,3-propanesultone and 1,5,2,4-dioxadithiane-2,2,4,4-tetraoxide.

### [Lithium Secondary Battery]

The lithium secondary battery of the present invention is the one in which the positive electrode active substance layer and the negative electrode active substance layer are disposed so as to face each other through a separator, and which has the electrolytic solution impregnated in the electrodes and an outer package accommodating these.

As the separator, a monolayer or laminated porous film or nonwoven fabric of a polyolefin such as polypropylene or polyethylene, aramid, polyimide and the like can be used. The separator further includes inorganic materials such as glass fibers, polyolefin films coated with a fluorine compound or inorganic microparticles, laminates of a polyethylene film and a polypropylene film, and a laminate of a polyolefin film with an aramid layer.

The thickness of the separator is, from the viewpoint of the energy density of the battery and the mechanical strength of the separator, preferably 5 to 50 μm, and more preferably 10 to 40 μm.

The lithium secondary battery may have any form of a monolayer or laminated coin battery, a cylindrical battery, a laminate-type battery and the like, as long as the above-mentioned constitution is applied.

Examples of the laminate-type lithium battery include ones made by alternately laminating a positive electrode, a separator and a negative electrode, connecting the respective electrodes to tabs of metal terminals, putting the resultant in an outer package formed of a laminate film or the like, injecting an electrolytic solution and sealing the resultant.

The outer package preferably has a strength of being capable of stably holding the positive electrode and the negative electrode laminated through the separator and the electrolytic solution impregnated therein, and has the electrochemical stability to these substances and the airtightness and watertightness. For the outer package, for example, stainless steel, nickel-plated iron, aluminum, titanium, or an alloy thereof or a plated one, or a metal laminate resin can be used. A metal laminate film is made by laminating a metal thin film on a thermally-fusible resin film. As the thermally-fusible resin, polypropylene, polyethylene, acid-modified polypropylene or polyethylene, polyphenylene sulfide, polyester such as polyethylene terephthalate, polyamide, an ionomer resin made by intermolecularly bonding an ethylene-vinyl acetate copolymer, an ethylene-methacrylic acid copolymer or an ethylene-acrylic acid copolymer with a metal ion, or the like can be used. The thickness of the thermally-fusible resin film is preferably 10 to 200 μm, and more preferably 30 to 100 μm.

As the metal thin film, for example, a foil of Al, Ti, a Ti alloy, Fe, stainless steel, a Mg alloy or the like having a thickness of 10 to 100 μm can be used. Further as the laminate film, one made by laminating a protection layer composed of a film of a polyester such as a polyethylene terephthalate, a polyamide or the like on the surface of the above laminate film having no metal thin film laminated thereon can be used.

One Example of the lithium ion secondary battery of the present invention is shown in the schematic constitution view of FIG. 2. In the lithium secondary battery shown in FIG. 2, a positive electrode 10 in which a positive electrode active substance layer 1 is provided on both surfaces each or one surface of positive electrode current collectors 1A each and a negative electrode 20 in which a negative electrode active substance layer 2 is provided on both surfaces each or one surface of negative electrode current collectors 2A each are laminated through porous separators 3, and packed together with an electrolytic solution (not shown in figure) in outer packages 4 composed of an aluminum-deposited laminate film. A positive electrode tab 1B formed of an aluminum plate is connected to a portion of the positive electrode current collectors 1A where no positive electrode active substance layer 1 is provided; and a negative electrode tab 2B formed of a nickel plate is connected to a portion of the negative electrode current collectors 2A where no negative electrode active substance layer is provided, and the tips of the tabs are led out the outer packages 4.

### EXAMPLES

Hereinafter, the lithium secondary battery of the present invention will be described in detail, but the present invention is not limited to these Examples.

### Example 1

### [Preparation of Positive Electrodes]

LiCo_{1/3}Ni_{1/3}Mn_{1/3}O₂ as a positive electrode active substance, a carbon black as a conductive auxiliary agent and a polyvinylidene fluoride as a binder for a positive electrode were weighed in a mass ratio of 94:3:3, and mixed with N-methylpyrrolidone to thereby make a positive electrode slurry. Then, the positive electrode slurry was applied on a positive electrode current collector 1A composed of an aluminum foil of 20 μm in thickness, thereafter dried and further pressed to thereby fabricate a positive electrode active substance layer 1. A double-sided electrode also was similarly fabricated by applying and drying a positive electrode active substance layer 1 on both surfaces each of a positive electrode current collector 1A.

### [Preparation of Negative Electrodes]

A natural graphite powder (spherical graphite) of 20 μm in average particle diameter and 5 m²/g in specific surface area was subjected to a first heat treatment heating in air at 480° C. for 1 hour, and then subjected to a second heat treatment heating in a nitrogen atmosphere at 1,000° C. for 4 hours to thereby prepare a heat-treated graphite material. The obtained heat-treated graphite material (94% by weight) and a polyvinylidene fluoride (6% by weight) were mixed, and slurried by adding N-methylpyrrolidone, and applied and dried on a negative electrode current collector 2A composed of a copper foil (thickness: 10 μm) to thereby fabricate a negative electrode active substance layer 2. A double-sided electrode also was similarly fabricated by applying and drying a negative electrode active substance layer 2 on both surfaces each of a negative electrode current collector 2A.

### [Preparation of an Electrolytic Solution]

A solvent was prepared in which ethylene carbonate (EC), dimethyl carbonate (DMC) and ethyl methyl carbonate (MEC) were mixed in a volume ratio of 20:40:40. Then, in the prepared solvent, a 0.65M LiPF₆ and a 0.65M LiN(SO₂F)₂ (abbreviated to LiFSI) were dissolved. Further 1% by mass of lithium difluorophosphate was dissolved to thereby prepare an electrolytic solution.

### [Preparation of a Lithium Battery]

After the above positive electrode and negative electrode were shaped, a battery as illustrated in FIG. 2 was fabricated. The positive electrode and the negative electrode were laminated by interposing a separator 3 of a porous film between the positive electrode active substance layers 1 each and the negative electrode active substance layers 2 each. A positive electrode tab 1B and a negative electrode tab 2B were welded to the positive electrode current collectors 1A and the negative electrode current collectors 2A, respectively. The resultant was interposed between rectangular outer packages 4 of an aluminum laminate film; three superposed sides of the outer packages 4 were thermally fused and sealed with one superposed side thereof left unfused; thereafter, the above electrolytic solution was impregnated under suitable vacuum. Thereafter, the remaining one superposed side of the outer packages 4, which had not been thermally fused, was thermally fused and sealed under reduced pressure.

After the sealing, the resultant battery was subjected to an activation treatment. The battery was charged at a charge current of 0.1 C to 4.2 V. Thereafter, the battery was discharged at a discharge current of 0.1 C to 2.5 V. The activation treatment was carried out by repeating twice this charge and discharge cycle to thereby fabricate a lithium battery.

### [Evaluation of the Lithium Battery]

The lithium battery fabricated by the above method was charged in a thermostatic chamber at 20° C. at a constant current of 0.1 C to 4.2 V, and discharged at a constant current of 0.1 C to 2.5 V. Then, the battery was charged at a constant current of 6 C to 4.2 V, and discharged at a constant current of 0.1 C to 2.5 V. Further, the battery was charged at a constant current of 10 C to 4.2 V, and discharged at a constant current of 0.1 C to 2.5 V. The charge capacity (6 CC) when the battery was charged at a constant current of 6 C and the charge capacity (0.1 CC) when the battery was charged at a constant current of 0.1 C were measured, and the ratio (6 CC/0.1 CC) of 6 CC to 0.1 CC was calculated to thereby determine the charge rate (6 C charge rate) when the battery was charged at a constant current of 6 C. Similarly, the charge capacity (10 CC) when the battery was charged at a constant current of 10 C was measured, and the ratio (10 CC/0.1 CC) of 10 CC to 0.1 CC was calculated to thereby determine the charge rate (10 C charge rate) when the battery was charged at a constant current of 10 C. The results are shown in Table 1. The values in the Table are relative values (%) when the charge capacity of 0.1 C is taken to be 100.

Here, “C” is a unit indicating a relative ratio of a current to a battery capacity in the discharge time or in the charge time, and a current value at which when a battery is discharged or charged at a constant current, the discharge or the charge is completed in 1 hour is taken to be 1 C.

### Example 2

A lithium secondary battery was fabricated and evaluated as in Example 1, except for altering the content of lithium difluorophosphate in the electrolytic solution to 0.2% by mass. The results are shown in Table 1.

### Example 3

A lithium secondary battery was fabricated and evaluated as in Example 1, except for altering the content of lithium difluorophosphate in the electrolytic solution to 2.5% by mass. The results are shown in Table 1.

### Example 4

A lithium secondary battery was fabricated and evaluated as in Example 1, except for changing EC, DMC and MEC of the solvent of the electrolytic solution to a solvent prepared by mixing EC and MEC in a volume ratio of 30:70. The results are shown in Table 1.

### Example 5

A lithium secondary battery was fabricated and evaluated as in Example 1, except for changing the 0.65M LiPF₆ and the 0.65M LiFSI in the electrolytic solution to a 1.3M LiFSI. The results are shown in Table 1.

### Example 6

A lithium secondary battery was fabricated and evaluated as in Example 1, except for changing the 0.65M LiPF₆ and the 0.65M LiFSI in the electrolytic solution to a 1.3M LiPF₆. The results are shown in Table 1.

### Example 7

A lithium secondary battery was fabricated and evaluated as in Example 1, except for altering the first heat treatment temperature to 650° C. in the preparation of the negative electrodes. The results are shown in Table 1.

### Example 8

A lithium secondary battery was fabricated and evaluated as in Example 1, except for changing the heat-treated graphite material of the negative electrode active substance to a mixture prepared by mixing the heat-treated graphite material and the graphite as a raw material of the heat-treated graphite material in a mass ratio of 3:1, in the preparation of the negative electrodes. The results are shown in Table 1.

### Example 9

A lithium secondary battery was fabricated and evaluated as in Example 1, except for changing the LiCo_{1/3}Ni_{1/3}Mn_{1/3}O₂ of the positive electrode active substance to a mixture prepared by mixing LiCo_{1/3}Ni_{1/3}Mn_{1/3}O₂ and LiMn₂O₄ in a mass ratio of 4:1 in the preparation of the positive electrodes. The results are shown in Table 1.

### Comparative Example 1

A lithium secondary battery was fabricated and evaluated as in Example 1, except for using the electrolytic solution containing no lithium difluorophosphate. The results are shown in Table 1.

### Comparative Example 2

A lithium secondary battery was fabricated and evaluated as in Example 5, except for using the electrolytic solution containing no lithium difluorophosphate. The results are shown in Table 1.

### Comparative Example 3

A lithium secondary battery was fabricated and evaluated as in Example 6, except for using the electrolytic solution containing no lithium difluorophosphate. The results are shown in Table 1.

### Comparative Example 4

A lithium secondary battery was fabricated and evaluated as in Example 1, except for changing lithium difluorophosphate to vinylene carbonate (VC). The results are shown in Table 1.

### Comparative Example 5

A lithium secondary battery was fabricated and evaluated as in Example 1, except for changing lithium difluorophosphate to fluoroethylene carbonate (FEC). The results are shown in Table 1.

### Comparative Example 6

A lithium secondary battery was fabricated and evaluated as in Example 7, except for using the electrolytic solution containing no lithium difluorophosphate. The results are shown in Table 1.

### Comparative Example 7

A lithium secondary battery was fabricated and evaluated as in Example 8, except for using the electrolytic solution containing no lithium difluorophosphate. The results are shown in Table 1.

### Comparative Example 8

A lithium secondary battery was fabricated and evaluated as in Example 9, except for using the electrolytic solution containing no lithium difluorophosphate. The results are shown in Table 1.

TABLE 1

| | | | | 6 C | 10 C |
|---|---|---|---|---|---|
| | Nonaqueous Solvent | Lithium | Another | Charge | Charge |
| | Electrolyte | Difluorophosphate | Additive | Rate ¹⁾ | Rate ²⁾ |
| Example 1 | EC/DMC/MEC(20/40/40) | 1% by mass | None | 74 | 65 |
| | 0.65M LiPF₆ + 0.65M LiFSI | | | | |
| Example 2 | EC/DMC/MEC(20/40/40) | 0.2% by mass | None | 72 | 63 |
| | 0.65M LiPF₆ + 0.65M LiFSI | | | | |
| Example 3 | EC/DMC/MEC(20/40/40) | 2.5% by mass | None | 75 | 67 |
| | 0.65M LiPF₆ + 0.65M LiFSI | | | | |
| Example 4 | EC/MEC(30/70) | 1% by mass | None | 72 | 62 |
| | 0.65M LiPF₆ + 0.65M LiFSI | | | | |
| Example 5 | EC/DMC/MEC(20/40/40) | 1% by mass | None | 76 | 68 |
| | 1.3M LiFSI | | | | |
| Example 6 | EC/DMC/MEC(20/40/40) | 1% by mass | None | 70 | 60 |
| | 1.3M LiPF₆ | | | | |
| Example 7 | EC/DMC/MEC(20/40/40) | 1% by mass | None | 75 | 66 |
| | 0.65M LiPF₆ + 0.65M LiFSI | | | | |
| Example 8 | EC/DMC/MEC(20/40/40) | 1% by mass | None | 72 | 63 |
| | 0.65M LiPF₆ + 0.65M LiFSI | | | | |
| Example 9 | EC/DMC/MEC(20/40/40) | 1% by mass | None | 74 | 64 |
| | 0.65M LiPF₆ + 0.65M LiFSI | | | | |
| Comparative | EC/DMC/MEC(20/40/40) | None | None | 64 | 54 |
| Example 1 | 0.65M LiPF₆ + 0.65M LiFSI | | | | |
| Comparative | EC/DMC/MEC(20/40/40) | None | None | 69 | 58 |
| Example 2 | 1.3M LiFSI | | | | |
| Comparative | EC/DMC/MEC(20/40/40) | None | None | 60 | 50 |
| Example 3 | 1.3M LiPF₆ | | | | |
| Comparative | EC/DMC/MEC(20/40/40) | None | VC | 63 | 50 |
| Example 4 | 0.65M LiPF₆ + 0.65M LiFSI | | 1% by mass | | |
| Comparative | EC/DMC/MEC(20/40/40) | None | FEC | 62 | 49 |
| Example 5 | 0.65M LiPF₆ + 0.65M LiFSI | | 1% by mass | | |
| Comparative | EC/DMC/MEC(20/40/40) | None | None | 64 | 52 |
| Example 6 | 0.65M LiPF₆ + 0.65M LiFSI | | | | |
| Comparative | EC/DMC/MEC(20/40/40) | None | None | 62 | 51 |
| Example 7 | 0.65M LiPF₆ + 0.65M LiFSI | | | | |
| Comparative | EC/DMC/MEC(20/40/40) | None | None | 63 | 52 |
| Example 8 | 0.65M LiPF₆ + 0.65M LiFSI | | | | |

¹⁾ Charge Capacity in 6 C Charge Time/Charge Capacity in 0.1 C Charge Time
²⁾ Charge Capacity in 10 C Charge Time/Charge Capacity in 0.1 C Charge Time

From the results, with respect to the 6 C charge rate and 10 C charge rate characteristics, it could be confirmed that Examples 1 to 9 were improved therein as compared with Comparative Examples 1 to 3 and 6 to 8.

Further in comparison of Example 1 with Comparative Examples 4 and 5, it could be confirmed that the charge rate characteristic in the case where the electrolytic solution contained lithium difluorophosphate was improved as compared with that in the cases where the additives conventionally used were added.

As described hitherto, in the lithium ion secondary battery using the heat-treated graphite material, the incorporation of lithium difluorophosphate in the electrolytic solution exhibits the excellent characteristic of being capable of improving the charge rate characteristic.

The present invention embraces the entire contents described in the description, the claims and the drawings in Japanese Patent Application No. 2015-182809.

### INDUSTRIAL APPLICABILITY

The lithium secondary battery of the present invention can be utilized in every industrial field necessitating power sources, and the industrial fields related to transport, storage and supply of electric energy. Specifically, the battery can be utilized as power sources for mobile devices such as cell phones, laptop computers, tablet computers and portable game machines. The battery can further be utilized as power sources for media for movement and transportation such as electric cars, hybrid cars, electric motorcycles, power-assisted bicycles, carts for transportation, robots and drones (small unmanned aircrafts). The battery can still further be utilized for backup power sources for household power storage systems, UPSs and the like, power storage facilities to store power generated by solar power generation, wind power generation and the like.

[Supplementary Notes]

A part or the whole of the above exemplary embodiment may also be described as the following supplementary notes, but is not limited to the following.

### [Supplementary Note 1]

A lithium secondary battery, comprising a positive electrode comprising a positive electrode active substance comprising a lithium transition metal oxide, a negative electrode comprising a negative electrode active substance comprising a heat-treated graphite material, and an electrolytic solution, wherein the heat-treated graphite material has a passage of lithium ions penetrating at least one or more layers of graphene layers from a surface of a graphene stacking structure; and the electrolytic solution comprises lithium difluorophosphate.

### [Supplementary Note 2]

The lithium secondary battery according to Supplementary Note 1, wherein the electrolytic solution contains the lithium difluorophosphate in a range of 0.005% by mass or more and 7% by mass or less.

### [Supplementary Note 3]

The lithium secondary battery according to Supplementary Note 1 or 2, wherein the electrolytic solution comprises one or more selected from chain carbonates and cyclic carbonates.

### [Supplementary Note 4]

The lithium secondary battery according to any one of Supplementary Notes 1 to 3, wherein the electrolytic solution comprises LiN(SO₂F)₂.

### [Supplementary Note 5]

The lithium secondary battery according to any one of Supplementary Notes 1 to 4, wherein the negative electrode active substance comprises a non-heat-treated graphite material.

### [Supplementary Note 6]

The lithium secondary battery according to any one of Supplementary Notes 1 to 5, wherein the lithium transition metal oxide comprises one or more selected from LiCoO₂, LiMnO₂, LiMn₂O₄, LiNiO₂, LiCo₁₋ₓNiₓO₂(0.01<x<1), LiNi_{1/2}Mn_{3/2}O₄, LiNiₓCo_{y}Mn_{z}O₂ (x+y+z=1), LiFePO₄, Li₁₊ₐNiₓMn_{y}O₂ (0<a≤0.5, 0<x<1, 0<y<1), Li₁₊ₐNiₓMn_{y}M_{z}O₂ (0<a≤0.5, 0<x<1, 0<y<1, 0<z<1, M is Co or Fe), Li_{α}Ni_{β}Co_{γ}Al_{δ}O₂ (1≤α≤1.2, β+γ+δ=1, β≥0.7, γ≤0.2)

### [Supplementary Note 7]

A method for producing a lithium secondary battery, comprising: subjecting a graphite material to a first heat treatment in an oxidizing atmosphere to prepare a first heat-treated graphite material; thereafter subjecting the first heat-treated graphite material to a second heat treatment in an inert gas atmosphere at a higher temperature than that in the first heat treatment to prepare a heat-treated graphite material; using the heat-treated graphite material to form a negative electrode; and mixing lithium difluorophosphate to form an electrolytic solution.

### [Supplementary Note 8]

The method for producing a lithium secondary battery according to Supplementary Note 7, wherein the lithium difluorophosphate is mixed in a range of 0.005% by mass or more and 7% by mass or less in the electrolytic solution.

### [Supplementary Note 9]

The method for producing a lithium secondary battery according to Supplementary Note 7 or 8, wherein one or more selected from chain carbonates and cyclic carbonates are mixed in the electrolytic solution.

### [Supplementary Note 10]

The method for producing a lithium secondary battery according to any one of Supplementary Notes 7 to 9, wherein LiN(SO₂F)₂ is dissolved as an electrolyte in the electrolytic solution.

### [Supplementary Note 11]

The method for producing a lithium secondary battery according to any one of Supplementary Notes 7 to 10, wherein the negative electrode is formed by adding a non-heat-treated graphite material.

### [Supplementary Note 12]

The method for producing a lithium secondary battery according to any one of Supplementary Notes 7 to 11, wherein the positive electrode is formed by using, as the lithium metal oxide, one or more selected from LiCoO₂, LiMnO₂, LiMn₂O₄, LiNiO₂, LiCo₁₋ₓNiₓO₂ (0.01<x<1), LiNi_{1/2}Mn_{3/2}O₄, LiNiₓCo_{y}Mn_{z}O₂ (x+y+z=1), LiFePO₄, Li₁₊ₐNiₓMn_{y}O₂ (0<a≤0.5, 0<x<1, 0<y<1), Li₁₊ₐNiₓMn_{y}M_{z}O₂ (0<a≤0.5, 0<x<1, 0<y<1, 0<z<1, M is Co or Fe), Li_{α}Ni_{β}Co_{γ}Al_{δ}O₂ (1≤α≤1.2, β+γ+δ=1, β≥0.7, γ≤0.2).

1. A lithium secondary battery, comprising: a positive electrode comprising a positive electrode active substance comprising a lithium transition metal oxide; a negative electrode comprising a negative electrode active substance comprising a heat-treated graphite material; and an electrolytic solution, wherein the heat-treated graphite material has a passage of lithium ions penetrating at least one or more layers of graphene layers from a surface of a graphene stacking structure; and the electrolytic solution comprises lithium difluorophosphate.

2. The lithium secondary battery according to claim 1, wherein the electrolytic solution contains the lithium difluorophosphate in a range of 0.005% by mass or more and 7% by mass or less.

3. The lithium secondary battery according to claim 1, wherein the electrolytic solution comprises one or more selected from chain carbonates and cyclic carbonates.

4. The lithium secondary battery according to claim 1, wherein the electrolytic solution comprises LiN(SO₂F)₂.

5. The lithium secondary battery according to claim 1, wherein the negative electrode active substance comprises a non-heat-treated graphite material.

6. The lithium secondary battery according to claim 1, wherein the lithium transition metal oxide comprises one or more selected from LiCoO₂, LiMnO₂, LiMn₂O₄, LiNiO₂, LiCo₁₋ₓNiₓO₂ (0.01<x<1), LiNi_{1/2}Mn_{3/2}O₄, LiNiₓCo_{y}Mn_{z}O₂ (x+y+z=1), LiFePO₄, Li₁₊ₐNiₓMn_{y}O₂ (0<a≤0.5, 0<x<1, 0<y<1), Li₁₊ₐNiₓMn_{y}M_{z}O₂ (0<a≤0.5, 0<x<1, 0<y<1, 0<z<1, M is Co or Fe), Li_{α}Ni_{β}Co_{γ}Al_{δ}O₂ (1≤α≤1.2, β+γ+δ=1, β≥0.7, γ≤0.2).

7. A method for producing a lithium secondary battery, comprising: subjecting a graphite material to a first heat treatment in an oxidizing atmosphere to prepare a first heat-treated graphite material; thereafter subjecting the first heat-treated graphite material to a second heat treatment in an inert gas atmosphere at a higher temperature than that in the first heat treatment to prepare a heat-treated graphite material; using the heat-treated graphite material to form a negative electrode; and mixing lithium difluorophosphate to form an electrolytic solution.

8. The method for producing a lithium secondary battery according to claim 7, wherein the lithium difluorophosphate is mixed in a range of 0.005% by mass or more and 7% by mass or less in the electrolytic solution.

9. The method for producing a lithium secondary battery according to claim 7, wherein one or more selected from chain carbonates and cyclic carbonates are mixed in the electrolytic solution.

10. The method for producing a lithium secondary battery according to claim 7, wherein LiN(SO₂F)₂ is dissolved in the electrolytic solution.
